(19) United States
(12) Patent Application Publication
(10) Pub. No.: US 2009/0178752 A1
(43) Pub. Date: Jul. 16, 2009

(54) PROTECTIVE FILM APPLICATOR TOOL, KIT, AND METHODS OF SHIELDING A SURFACE

(76) Inventors: Kyle William Behringer, Mokena, IL (US); Jamey Lynne Alexander Behringer, Mokena, IL (US)

Correspondence Address: Patent Docket Department;Armstrong Teasdale LLP, One Metropolitan Square, Suite 2600, St. Louis, MO, 63102-2740, US

(21) Appl. No.: 12/350,845

(22) Filed: Jan. 8, 2009

Related U.S. Application Data
(60) Provisional application No. 61/020,592, filed on Jan. 11, 2008.

(51) Int. Cl. B32B 37/12

(52) U.S. Cl. 156/71; 156/579

(57) ABSTRACT

A tool, kit, and method for applying an elongated protective film material to a surface. The tool includes a roll of sticky protective film wound so that the sticky surface is on the outside of the roll, a mounting portion to hold the roll while letting it rotate and a handle for ease of guiding the tool during use.

### CROSS REFERENCE TO RELATED APPLICATIONS

This application claims the benefit of the filing date of U.S. Provisional Application No. 61/020,592 filed on Jan. 11, 2008, which is hereby incorporated by reference in its entirety.

### BACKGROUND OF THE INVENTION

The field of the invention relates generally to protective shields for isolating selected portions of construction and remodeling projects, and more specifically to a tool, a kit and methods for applying and adhering a protective film to a surface.

Protective films and covers, sometimes referred to as “shields” are widely utilized in the construction and remodeling industry to isolate, for example, finished elements and features on a job site that are proximate to, or in the midst of, unfinished elements and features on the job site. By virtue of such shields, some elements and features on the job site may be preserved and protected in good condition while work may be conducted in nearby locations. The shields prevent protected surfaces from being soiled, stained, marred, scuffed, scratched or otherwise adversely impacted by construction or remodeling activities. For certain items and surfaces, existing shield materials can be difficult to properly apply and install and improvements are desired.

### BRIEF DESCRIPTION OF THE INVENTION

In one embodiment, an applicator tool for applying an elongated protective film material to a surface to be protected is disclosed. The protective film material comprises a sheet of solid film continuously wound upon itself in a roll for a plurality of turns. The protective film material has an exposed tacky surface on an exterior of the roll and a non-tacky surface opposite the tacky surface. The applicator tool comprises a film mounting portion adapted to engage the roll of protective film material and facilitate rotation of the roll of protective film material on the surface to be protected when the exposed tacky surface of the roll is in direct contact with the surface to be protected. A handle portion is coupled to the film mounting portion for moving the film mounting portion relative to the surface to be protected, thereby rotating the film mount and adhering the tacky surface to the surface to be protected when the handle is moved to advance the roll of protective film material in a predetermined direction.

Optionally, the film mounting portion may engage a central aperture in the roll of material. The film mounting portion may be adapted to support the roll from only one side of the roll. The surface to be protected may be selected from the group of a carpeted floor, a wood floor, a tile floor, a concrete floor, a laminate floor, a vinyl floor, a wall, a window, a step, a piece of furniture, and a countertop. The handle portion may be extendable and retractable to adjust an axial length of the handle.

In another embodiment, a hand held surface shield applicator tool is disclosed. The applicator tool comprises a handle portion configured to be gripped with a single hand of a user; a film mounting portion rotatably coupled to the handle portion; and an elongated protective film material continuously wound upon itself in a roll for a plurality of turns. The protective film material has an exposed tacky surface on an exterior of the roll and a non-tacky surface opposite the tacky surface. The roll is mounted on the film mounting portion to facilitate rotation of the roll when the exposed tacky surface of the roll is in direct contact with a surface to be protected, and the handle is movable relative to the surface to be protected to simultaneously rotate the roll and adhere the tacky surface to the surface to be protected, thereby providing an elongated shield on the surface to be protected. The shield has at least a length corresponding to a plurality of turns of the roll.

Optionally, the film mounting portion may be slidable into a central aperture in the roll of material. The film mounting portion may support the roll from only one side of the roll. The surface to be protected may be selected from the group of a carpeted floor, a wood floor, a tile floor, a concrete floor, a laminate floor, a vinyl floor, a wall, a step, a window, a piece of furniture, and a countertop. Only the tacky surface of the roll may engage the surface to be protected as the handle portion is moved. The surface to be protected comprises a substantially planar surface that is one of vertically oriented or horizontally oriented.

In another embodiment a kit for shielding a substantially planar surface is disclosed. The kit comprises an applicator tool having a handle portion defining a hand grip and a film mounting portion that is rotatable relative to the hand grip. At least one elongated protective material is provided that is continuously wound upon itself in a roll for a plurality of turns. The protective film material has an exposed tacky surface on an exterior of the roll and a non-tacky surface opposite the tacky surface, wherein the roll is removably mountable to the film mounting portion to simultaneously rotate the roll in direct engagement with the substantially planar surface to be protected and adhere the tacky surface to the substantially planar surface to be protected, thereby providing an elongated shield on the surface to be protected having at least a length corresponding to a plurality of turns of the roll.

Optionally, the film mounting portion may be slidable into a central aperture in the roll of material. The film mounting portion may extend from only one side of the roll. The tacky surface of the roll may engage the substantially planar surface, and the film mounting portion may not engage the substantially planar surface. The substantially planar surface may comprise one of a vertically oriented surface and a horizontally oriented surface. The substantially planar surface may comprise one of a floor, a wall, a step, a window, a countertop and a piece of furniture.

A method of shielding a surface to be protected on a construction or remodeling job site is also disclosed. The method comprises providing a roll of elongated protective film material continuously wound upon itself for a plurality of turns, the surface shield material having an exposed tacky surface on an exterior of the roll and a non-tacky surface opposite the tacky surface. The method further comprises providing a hand-held applicator tool having a handle portion and a film mounting portion; mounting the roll to the film mounting portion; directly engaging the tacky surface of the roll to the surface to be protected; and guiding, using the handle portion, the tacky surface of the roll over the surface to be protected in a predetermined direction, thereby simultaneously rotating the roll and adhering the tacky surface to the surface to be protected, thereby providing an elongated shield over the surface to be protected.

Optionally, guiding the tacky surface of the roll comprises guiding the tacky surface of the roll along a substantially planar surface, the planar surface extending in one of a vertically oriented plane and a horizontally oriented plane.

In another embodiment, a shield for protecting a surface is disclosed. The shield comprises a carrier tube comprising a central aperture and an external surface and an elongate protective film material. The film material is continuously wound upon itself in a roll for a plurality of turns and an inner surface of the roll is coupled to the carrier tube external surface. The protective film material has an exposed tacky surface on an exterior of the roll and a non-tacky surface opposite the tacky surface. The protective film material is less than about 24 inches wide and is configured to separate from the roll and adhere to a surface to be protected.

### BRIEF DESCRIPTION OF THE DRAWINGS

FIG. 1 is a perspective view of a known adhesive film and applicator for protecting a surface.

FIG. 2 is a perspective view of another type of protective film for protecting a surface.

FIG. 3 illustrates an applicator tool for the film shown in FIG. 2 in accordance with an exemplary embodiment of the invention.

FIG. 4 is a side elevational view of the applicator tool shown in FIG. 3 in use to apply the shield.

FIG. 5 is a perspective view of another embodiment of an applicator tool in a first operating condition.

FIG. 6 is an elevational view of the tool shown in FIG. 5 in a second operating position.

FIG. 7 is an exemplary flowchart of a method of shielding a surface with the applicator tool.

### DETAILED DESCRIPTION OF THE INVENTION

The following detailed description illustrates embodiments of the invention by way of example and not by way of limitation. It is contemplated that the invention has general application to protective shields for isolating selected portions of construction and remodeling projects, and more specifically to a tool, kit and methods for applying and adhering a protective film to a surface.

Exemplary embodiments of applicator tools, kits and methods for applying adhesive protective films for selected surfaces on construction and remodeling job sites are described in detail below. The applicators, tools, kits and methods facilitate secure and reliable placement and application of the protective films with minimal time and by a single person. The tools, kits and methods are applicable to a variety of different sizes of films for protecting a wide variety of surfaces on a job site.

A. Introduction

It is often desirable to shield certain elements and features on a construction or remodeling site from potentially adverse effects while work is being conducted. As one example, it is often desirable to protect an existing floor, or a newly installed one, from construction traffic, dust, tools, paint and other construction materials that may otherwise soil, negatively impact or ruin a carpeted, wood, laminate, vinyl, or tiled surface. As another example, it is often desirable to shield and protect a newly installed countertop, or one in good condition, during construction and remodeling activities in the vicinity of the countertop.

Some protective films that are suitable to shield such surfaces are available in rolls wherein protective material is wound upon itself for compact storage and transport to a job site. When needed, the rolls may be placed on designated surfaces to be protected by unrolling the material on the designated surfaces to provide a protective barrier shield on the designated surfaces. The shields are removable when work is complete or when the shielding is no longer necessary.

Certain types of protective films are adhered to the surfaces to be protected on the job site so that their position can be maintained, and also to form a seal between the film and the surface being protected. While such adhesive shields are beneficial to protect such surfaces, they can be inconvenient, and sometimes difficult, to install.

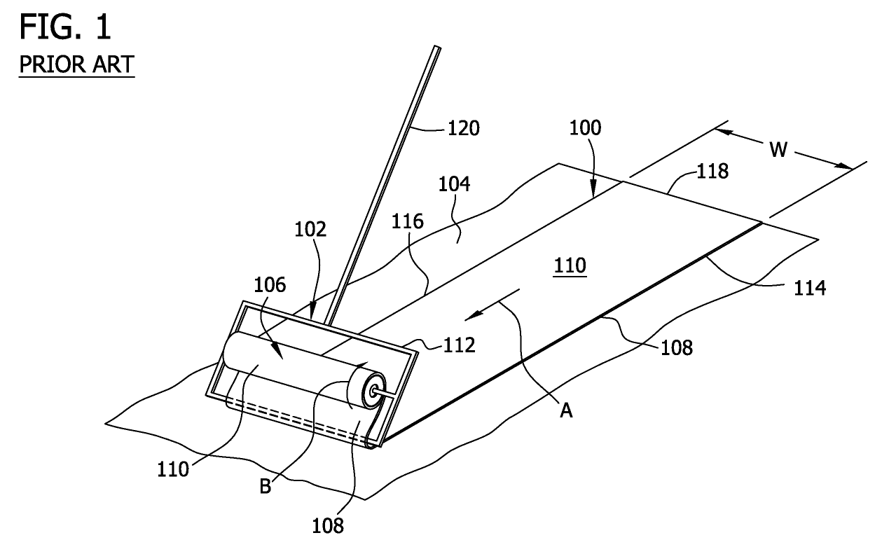

FIG. 1 is a perspective view of a known adhesive film 100 and applicator 102 for protecting a surface 104, such as, for example only, a carpeted floor on a job site. The film 100 is generally provided as a single, solid, and continuous sheet of material that is continuously wound upon itself in a roll 106 for a plurality of turns. The roll 106 provides for convenient and compact storage prior to use of the film 100. When unrolled, the film 100 provides a strip of a thin skin or membrane on the surface to be protected 104 to shield and protect it from adverse effects of surrounding work in the area of the film 100. Multiple strips of film 100 may be provided side-by-side or overlapping one another to shield larger areas of the surface 104 to be protected on the site. The film 100 may be fabricated from a variety of known materials and is generally available in a variety of sizes, such as 24 inch, 36 inch and even 48 inches in width W measured between lateral side edges 114, 116 of the film 100. The length of the film, measured generally perpendicular to the dimension W, may range from, for example, about 30 feet to 200 feet. The film 100 may be cut to any desired length by the user.

The film 100 is provided with opposing major surfaces 108 and 110. The major surface 108 is provided with a pressure-sensitive adhesive that renders it tacky and adherent to the surface 104 to form a protective barrier seal with the surface 104 to be protected. The opposing major surface 110 of the film 100 does not include an adhesive and is not tacky. The roll 106 is wound such that the tacky surface 108 faces inwardly and the non-tacky surface 110 faces outwardly. That is, the non-tacky surface 110 is exposed on the outer surface of the roll 106 and the tacky surface 108 is not.

To assist with installing the film 100, an applicator 102 has been provided that commonly includes a generally rectangular frame 112 that suspends the roll 106 above the surface 104 to be protected. A handle 120 extends from an upper portion of the applicator frame 112, and the film 100 is partly unrolled from the roll 106 and drapes around a lower portion of the frame 112 such that the tacky surface 108 of the film passes under the lower portion of the frame 112 to engage it with the surface 104 to be protected. A person gripping the handle 120 may walk behind the frame 112 and push the frame 112 along the surface 104 to adhere the film 100 to the surface 104. The lower portion of the frame 112 smoothly presses the tacky surface 108 to the surface 104, and tension in the film 100 causes the suspended roll 106 to rotate in the direction of arrow B and release more of the tacky surface 108 for application to the surface 104. Thus, the applicator 102 serves both to dispense the film 100 from the roll 106 and apply the film 100 to the surface 104 to be protected.

The applicator 102 presents a number of difficulties to certain users. The relatively large-sized rolls 106 (24 inch, 36 inch and 48 inch rolls) require a relative large and sturdy applicator 102 that can be costly, cumbersome to use, difficult to transport to a job site, and requires substantial storage space when not in use. The applicator 102 is convenient for large open settings such as industrial, commercial, and institutional facilities, but because of its size it is not well suited for smaller areas and settings, such as residential projects, having smaller areas and corners. The applicator 102 is therefore generally impractical for do-it-yourself projects and for occasional users of protective films.

The applicator 102 also is not well suited for certain applications. The size, weight, and bulk of the rolls 106 and applicator 102 renders it practically useless to apply film to vertical surface such as walls or windows, and also for some smaller horizontal floor surfaces and elevated horizontal surfaces from a floor, such as a countertop or stair step. It is not well suited for certain floor applications either, such as applying the film 100 to a floor that adjoins a wall that is to be painted, because the lateral edges 114 and 116 of the film 100 are inwardly spaced from the outer lateral edges of the applicator frame 112, thereby leaving a small, and undesirable gap between one lateral edge 114 or 116 of the film 100 and the wall that is to be painted.

Still further, because of the size and bulk of the rolls 106 and the applicator frame 112, it can be difficult for one person to properly install and suspend a roll 106 on the applicator frame 112 and to apply the distal end 118 of the film 100 to the surface 104 to be protected. That is, an assistant is often required to install and suspend a roll 106 of film 100, drape it over the lower portion of the applicator frame 112, and properly adhere the distal end 118 of the film 100 to the surface 104 and for an ensuing initial distance in the direction of arrow A until one operator can effectively push the applicator 102 alone to dispense and apply the film 100 for a desired distance. The need for multiple workers to install the film 100 consumes time and labor costs that may be more beneficially spent on other tasks.

For at least the above reasons, the rolls 106 and the applicator 102 are not very user friendly or practical to many potential users that desire to apply a protective film to surfaces on a job site. It would be desirable to provide an easier to use and more universally applicable applicator for a wider variety of applications of protective films on a job site.

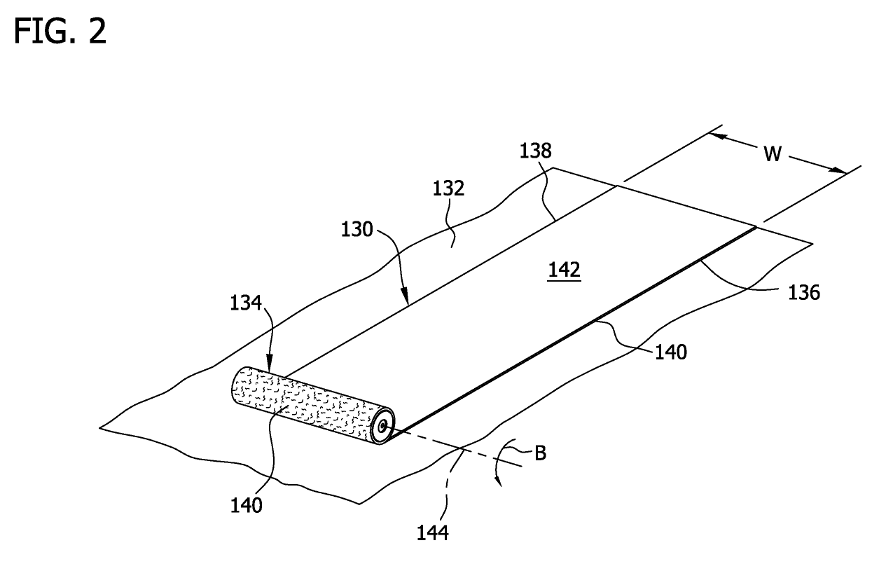

FIG. 2 illustrates another type of protective film 130 for protecting a surface 132 on a job site. Like the film 100 described in relation to FIG. 1, the film 130 in FIG. 2 is generally provided as a single, solid, and continuous sheet of material, such as polyethylene, that is continuously wound upon itself in a roll 134 for a plurality of turns for convenient and compact storage prior to use of the film 130. When unrolled, the film 130 provides a strip of a thin skin or membrane on the surface to be protected 132 to shield and protect it from adverse effects of surrounding work in the area of the film 130. Multiple strips of film 130 may be provided side-by-side or overlapping one another to shield larger areas of the surface 132 to be protected on the site. The film 130 is also available in a variety of sizes, such as 21 inch, 24 inch, 36 inch and even 48 inches in width W measured between lateral side edges 136, 138 of the film 130. The length of the film, measured generally perpendicular to the dimension W may range from, for example, about 30 feet to 200 feet. The film 130 may be cut to any desired length by the user.

Like the film 100, the film 130 is provided with opposing major surfaces 140 and 142. The major surface 140 is provided with a pressure-sensitive adhesive that renders it tacky and adherent to the surface 132 to form a protective barrier seal with the surface 132 to be protected. The opposing major surface 142 of the film 130 does not include an adhesive and is not tacky. Unlike the roll 106 shown in FIG. 1, the roll 134 is wound such that the tacky surface 140 faces outwardly and the non-tacky surface 142 faces inwardly. That is, the tacky surface 140 is exposed on the outer surface of the roll 134 and the non-tacky surface 142 is not. That is, compared to the roll 106 of FIG. 1, the roll 134 is reversed or oppositely wound with the tacky surface 140 exposed on the outer exterior surface of the roll 134.

The reverse winding of the roll 134 is advantageous over the roll 106 in some aspects. The tacky surface 140 of the roll 134 may be directly engaged to the surface 132 to be protected, and the applicator 102 shown in FIG. 1 and its accompanying drawbacks may be avoided. That is, the roll 134 may be simply placed in surface engagement with the surface 132 to be protected, and rotated by the user about the axis 144 of the roll 134 in the direction of arrow B to unwind or unroll the film 130 on the surface 132. The roll 134 is much more amenable to application by a single person than the roll 106.

The roll 134 is not without drawbacks, however. The exposed tacky surface 140 on the outer surface of the roll 134 can make it somewhat difficult, or unpleasant, to rotate about the axis 144 by hand in an even manner. In floor installations, the roll 134 may be unrolled with a person's feet, but this can be difficult to do in an even manner, often resulting in undesirable voids and incomplete adherence and surface engagement of the film 130 with the surface 132 to be protected. Because of the size of the roll 134, it may very well require more than one person to reliably and uniformly adhere the film 130 to the surface 132 to be protected, and the roll 134 is not very practical, if at all, for relatively small surfaces. It would be difficult, to say the least, to use the roll 134 on an inclined or vertically oriented surface on a job site.

B. Inventive Embodiments of Protective Film Applicators, Kits and Methods

Unique and advantageous embodiments of protective film applicators, tools, and methods of shielding surfaces that may be used more or less universally across a wide variety of different surfaces on a job site are disclosed hereinafter. The applicators and tools may be provided at relatively low cost to users, and the methods may be capably, easily, and quickly performed by a single person. The uniqueness, benefits and advantages of the tools, kits and methods will in part be apparent and in part will be pointed out in the discussion below.

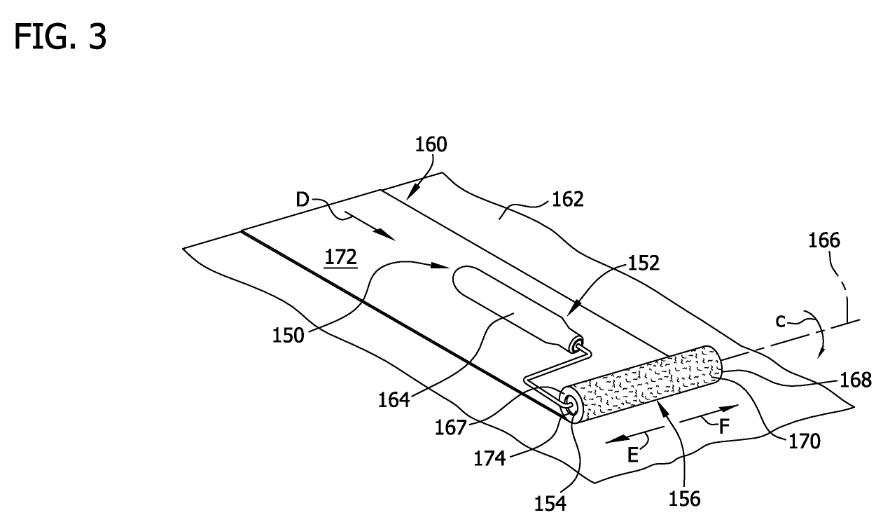

FIG. 3 illustrates an exemplary applicator tool 150 that overcomes numerous disadvantages in the art, including but not limited to those discussed above. The applicator tool 150 generally includes a handle portion 152, a film mounting portion 154, and a roll 156 of protective film 160 that may be unrolled, using the applicator tool 150 as explained below, to cover and shield a substantially planar surface 162 on a construction or remodeling job site.

The handle portion 152 in the illustrative embodiment depicted in FIG. 3 defines a contoured hand grip 164 that may be conveniently gripped with one hand. The handle portion 152 may extend as shown in FIG. 3 in a generally perpendicular orientation to the longitudinal axis 166 of the roll 156, although in other embodiments, the handle portion 152 may be oriented differently relative to the roll 156, such as obliquely to the roll axis 166 or parallel to the axis 166 if desired. A variety of shapes, dimensions, and configurations of the handle portion 152 are possible in further and/or alternative embodiments without departing from the scope and spirit of the invention, and while still obtaining the benefits of the inventive concepts disclosed herein.

Also, as shown in FIG. 3, the handle portion 152 is approximately centered along the longitudinal axis 166 of the roll 156, although in another embodiment the handle could be positioned elsewhere as desired.

The film mounting portion 154 is rotatably mounted to the handle portion 152 such that the film mounting portion 154 may rotate about the roll axis 166 in the direction of arrow C when the handle portion 152 is moved relative to the surface 162 to be protected in the direction of arrow D. The film mounting portion 154 extends from and is supported by the handle portion 152 on only one lateral end 167 of the roll 156, leaving the opposing end 168 of the roll 156 generally free and clear of any obstruction. As such, the film 160 can be applied with the applicator tool 150 to, for example, a horizontal surface at a location where it adjoins a vertical surface such as a wall or trim piece, without leaving a gap on the surface to be protected by abutting the free lateral end 168 of the roll 156 immediately proximal to or against the vertical surface.

The roll 156, similar to the roll 134 described in relation to FIG. 2, includes opposing major surfaces 170 and 172. The surface 170 is provided with a known pressure sensitive adhesive rendering the surface 170 to be tacky, and the tacky surface 170 is exposed on the outer exterior surface of the roll 156. The tacky surface 170 is appropriately formulated to be easily removed and peeled off the surface 162 to be protected when no longer needed without leaving any residue on the surface 162. The surface 172 is not tacky and is outward facing and exposed when the film 160 is applied and adhered to the surface 162 to be protected. The non-tacky surface 172 may be finished with non-slip coatings and the like as desired. The film 160 is provided in a solid and substantially continuously extending sheet of material, such as a polyethylene blend or equivalent material that is tear resistant and puncture resistant. The film 160 may be transparent or opaque in different embodiments.

Like the roll 134 shown in FIG. 2, the sheet of film material is wound upon itself for a plurality of turns about the roll axis 166. The roll 156 may be provided on a carrier tube 174 fabricated from cardboard, for example, or another suitable material known in the art. Unlike the roll 134, the roll 156 is substantially smaller and lighter. As an example, in one embodiment the roll 156 is approximately 9 and ⅛ inches wide and has an axial length of about 50 feet, thereby significantly reducing the size and weight of the roll 156, and the complexity and difficulties of installing the film. Of course, other widths and lengths of film may be used, whether greater or smaller than those specifically identified above, in other embodiments. For example only, the roll 156 may vary from about one inch wide to about twenty-four inches wide with lengths ranging from about one foot to over fifty feet. Of course, other widths and lengths of film may be used, whether greater or smaller than those specifically identified above, in other embodiments.

The roll 156, and more specifically a central aperture of the carrier tube 174, may be fitted to the film mount portion 154 of the applicator tool 150 with slight interference and slip-fit engagement between the carrier tube 174 of the roll 156 and the film mounting portion 154. Rotatable elements and mechanisms suitable for use as the film mounting portion 154 are well known and specific discussion thereof will be accordingly omitted. The roll 156 may be slip fit on the film mounting portion 154 with force applied along the roll axis 166 in the direction of arrow E, and removed with force applied along the roll axis 166 in the direction of arrow F opposite to the direction of arrow E.

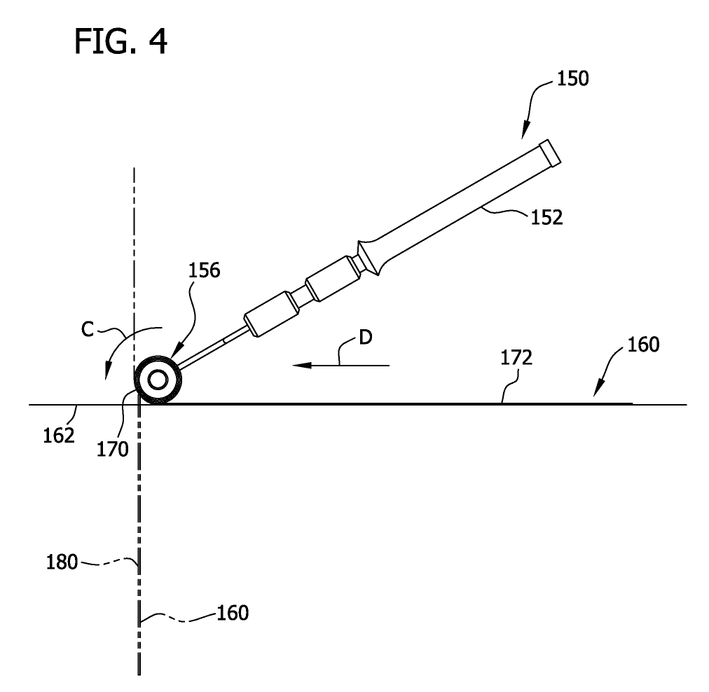

Referring now to FIG. 4, the handle portion 152 may be gripped by a user and the outer tacky surface 170 exposed on the outer exterior surface of the roll 156 may be directly engaged, with surface-to-surface engagement, with the surface 162 to be protected on a job site. With slight pressure to maintain the roll 156 in contact with the surface 162 to be protected, and with slight force applied to the handle portion 152 to move the applicator 150 in a direction parallel to the surface 162 to be protected (the direction of arrow D in FIG. 4), the roll 156 may be simultaneously rotated in the direction of arrow C and pressed into firm, substantially even and uniform adherence with the surface 162 to be protected. As such, the thin film 160 is rather easily unrolled into a planar orientation and reliably secured to the surface 162 to be protected.

The applicator tool 150, including the roll 156 is lightweight and may be easily gripped and used by one person to apply the film 160. The applicator tool 150 also is versatile and may be used to apply film 160 to a vertically oriented surface 180 (shown in phantom in FIG. 4). The tool 150 is also amenable to use on elevated surfaces such as countertops, table tops, other furniture pieces, and stair steps. The relatively small size of the applicator tool 150 allows for use in a variety of spaces large and small, including corner areas and intersections of vertical and horizontal surfaces.

Special formulations of film material may be provided in rolls 156 of various sizes in various embodiments for use on surfaces with different properties and textures, including but not limited to carpeted surfaces of varying piles, wood surfaces, laminate surfaces, vinyl surfaces, metallic surfaces, tile surfaces (e.g., glass, ceramic and stone), countertop surfaces (e.g., granite, marble, veneer, laminate), concrete and cement surfaces, painted surfaces, windows and doors of all types, and upholstery and fabrics. Still other surfaces could be protected with specifically formulated film materials optimal for specific attributes of the surfaces. An inventory of film materials may be maintained and universally applied with the same applicator tool 150. The inventory may be color-coded, for example, to easily distinguish one type of roll for another. Alternatively, special purpose applicator tools having optimized shapes, sizes, and colors, but otherwise comparable functional features, may likewise be developed for use on specific surfaces and specific locations.

Cutting edges and the like may be provided in further alternative embodiments of the inventions to facilitate the film 160 being cut to length for a specific project. Otherwise, the film 160 may be cut with a utility knife or other tool separate from the applicator tool 150.

Applicator tools 150 and protective film rolls 156 may be provided to users as kits in another aspect of the invention. For example, an applicator tool 150 may be packaged and sold together with, say, three film rolls 156 of the same or different types. The user may select a roll 156 for a project and mount it the applicator tool 150 for use, and when the roll is consumed the user may easily replenish the tool 150 with another roll 156, or exchange one roll with another for protecting different surfaces.

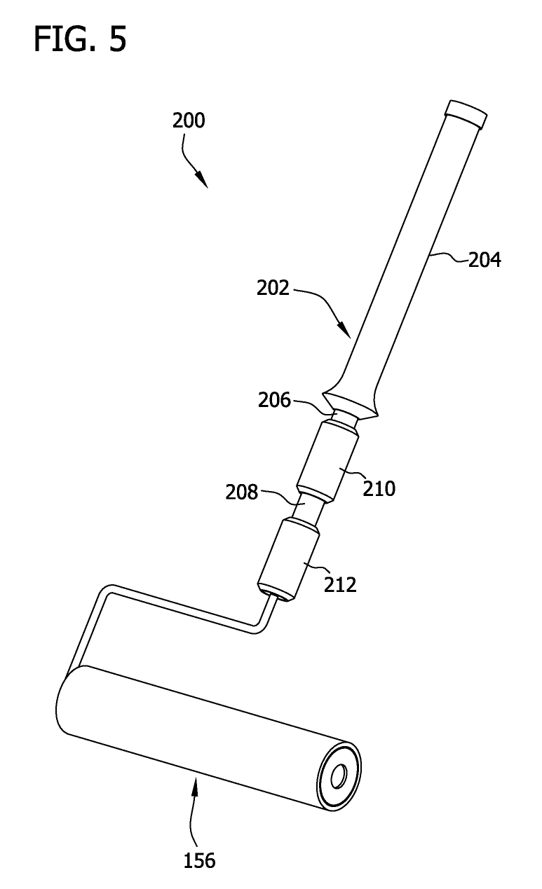

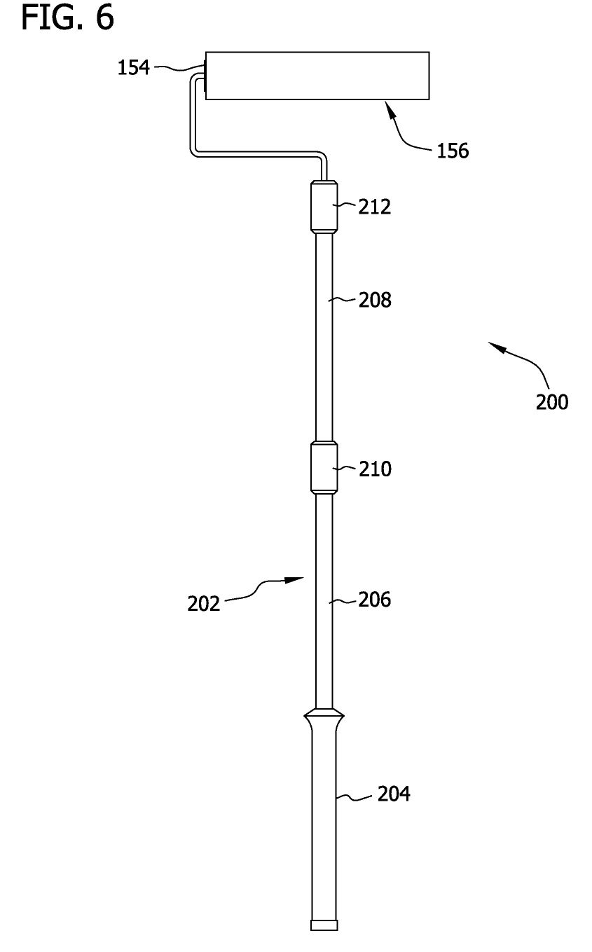

FIGS. 5 and 6 illustrate another embodiment of an exemplary applicator tool 200 that in some aspects is similar to the applicator tool 150 shown in FIGS. 3 and 4. Like features in FIGS. 3 and 4 are therefore designated with like reference characters in FIGS. 5 and 6.

The applicator tool 200 includes the film mounting portion 154 and roll 156 of adhesive film as described above. Unlike the tool 150 having a relatively short and truncated handle portion 152, the applicator tool 200 includes an extendible handle portion 202 having a first section 204 defining a hand grip for a user, a second section 206 that telescopes within the first section 204, and a third section 208 that telescopes within the second section 206 so that the handle portion 202 can be extended (FIG. 6) or retracted (FIG. 5) to different lengths as desired by a user. Twist-type couplers 210 and 212, familiar to those in the art, may be utilized to secure or release the telescoping sections 206 and 208 to obtain a user-selected length of the handle portion 202 appropriate for a given job. The extendible handle portion 202 may be particularly advantageous for applying the protective films to floor surfaces, wall surfaces, and windows, for example, to reduce the effort required by the user to install the film.

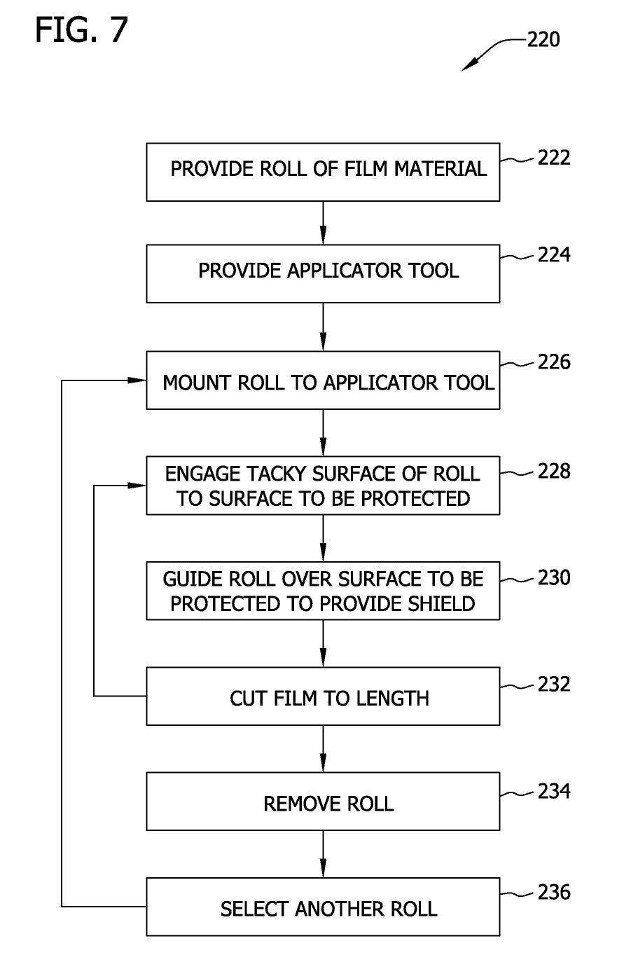

FIG. 7 is an exemplary flowchart of a method 220 of shielding a surface with an applicator tool, such as the tools 150 and 200 described above. The method includes providing 222 a roll of elongated protective film material, such as a roll 156 described above, that is continuously wound upon itself for a plurality of turns, and having an exposed tacky surface on an exterior of the roll and a non-tacky surface opposite the tacky surface. The method also includes providing 224 a hand-held applicator tool having a handle portion and a film mounting portion. The steps of providing 222 and 224 the roll and the applicator tool may occur at the job site or at another location, may not involve a sale of either the roll or the applicator tool, and need not occur at the same time or in any particular order or sequence to perform the steps 222 and 224.

Once provided, the user may mount 226 the roll to the film mounting portion of the applicator tool as previously described, and directly engage 228 the tacky surface of the roll to the surface to be protected. The user then may guide 230, using the handle portion, the tacky surface of the roll over the surface to be protected in a predetermined direction, thereby simultaneously rotating the roll and adhering the tacky surface to the surface to be protected, and providing an elongated shield over the surface to be protected. After cutting 232 to a desired length to complete the shield, the user may choose another surface to be protected and return to step 228.

If desired, the user may remove 234 the roll from the tool, select 236 another roll of film, and return to step 226.

A variety of substantially planar surfaces, whether in horizontal planes, vertical planes or sloped planes that are oblique to vertical and horizontal planes, may be preserved and protected using the above-described methodology.

It is understood that additional steps, and omission and modification of the steps described are contemplated. For example, the tool may be provided with the roll mounted thereon so as to render the steps 222, 224, and 226 unnecessary. As another example, additional steps of extending and retracting the tool handle portion may be performed in connection with the method between any of the illustrated steps. Further additional steps that are contemplated include cleaning of the surface to be protected prior to installing the protective film to ensure optimal bonding of the film, and removing the film after construction or remodeling work is completed. If desired, more than one applicator tool may be provided so that more than one person can apply protective film.

The benefits of the invention are now believed to have been amply demonstrated along with how disadvantages in the art are overcome. The applicator tools, kits, and methodology disclosed may be provided and performed at relatively low cost with much appeal to professional contractors and workers, as well as lay people seeking to undertake home improvements and renovations on their own.

While the invention has been described in terms of various specific embodiments, those skilled in the art will recognize that the invention can be practiced with modification within the spirit and scope of the claims.

What is claimed is:

1. An applicator tool for applying an elongate protective film material to a surface to be protected, the protective film material comprising a sheet of solid film continuously wound upon itself in a roll for a plurality of turns, the protective film material having an exposed tacky surface on an exterior of the roll and a non-tacky surface opposite the tacky surface, the applicator tool comprising:
a film mounting portion adapted to engage the roll of protective film material and facilitate rotation of the roll of protective film material on the surface to be protected when the exposed tacky surface of the roll is in direct contact with the surface to be protected; and
a handle portion coupled to the film mounting portion for moving the film mounting portion relative to the surface to be protected, thereby rotating the film mount and adhering the tacky surface to the surface to be protected when the handle is moved to advance the roll of protective film material in a predetermined direction.

2. The applicator tool of claim 1, wherein the film mounting portion engages a central aperture in the roll of material.

3. The applicator tool of claim 1, wherein the film mounting portion is adapted to support the roll from only one side of the roll.

4. The applicator tool of claim 1, wherein the surface to be protected is selected from the group of a carpeted floor, a wood floor, a tile floor, a concrete floor, a laminate floor, a vinyl floor, a wall, a window, a step, a piece of furniture, and a countertop.

5. A hand held surface shield applicator tool comprising:
a handle portion adapted to be gripped with a single hand of a user;
a film mounting portion rotatably coupled to the handle portion; and
an elongate protective film material continuously wound upon itself in a roll for a plurality of turns, the protective film material having an exposed tacky surface on an exterior of the roll and a non-tacky surface opposite the tacky surface;
wherein the roll is mounted on the film mounting portion to facilitate rotation of the roll when the exposed tacky surface of the roll is in direct contact with a surface to be protected; and
whereby the handle is movable relative to the surface to be protected to simultaneously rotate the roll and adhere the tacky surface to the surface to be protected, thereby providing an elongate shield on the surface to be protected, the shield having at least a length corresponding to a plurality of turns of the roll.

6. The applicator tool of claim 5, wherein the film mounting portion is slidable into a central aperture in the roll of material.

7. The applicator tool of claim 5, wherein the film mounting portion supports the roll from only one side of the roll.

8. The applicator tool of claim 5, wherein the surface to be protected is selected from the group of a carpeted floor, a wood floor, a tile floor, a concrete floor, a laminate floor, a vinyl floor, a wall, a step, a window, a piece of furniture, and a countertop.

9. The applicator tool of claim 5, wherein only the tacky surface of the roll engages the surface to be protected as the handle portion is moved.

10. The applicator tool of claim 5, wherein the surface to be protected comprises a substantially planar surface that is one of vertically oriented or horizontally oriented.

11. A kit for shielding a substantially planar surface, the kit comprising:
an applicator tool having a handle portion defining a hand grip and a film mounting portion that is rotatable relative to the hand grip; and
at least one elongate protective material continuously wound upon itself in a roll for a plurality of turns, the protective film material having an exposed tacky surface on an exterior of the roll and a non-tacky surface opposite the tacky surface;
wherein the roll is removably mountable to the film mounting portion to simultaneously rotate the roll in direct engagement with the substantially planar surface to be protected and adhere the tacky surface to the substantially planar surface to be protected, thereby providing an elongate shield on the surface to be protected having at least a length corresponding to a plurality of turns of the roll.

12. The kit of claim 11, wherein the film mounting portion is slidable into a central aperture in the roll of material.

13. The kit of claim 11, wherein the film mounting portion extends from only one side of the roll.

14. The kit of claim 11, wherein the tacky surface of the roll engages the substantially planar surface, and the film mounting portion does not engage the substantially planar surface.

15. The kit of claim 11, wherein the substantially planar surface comprises one of a vertically oriented surface and a horizontally oriented surface.

16. The kit of claim 11, wherein the substantially planar surface comprises one of a floor, a wall, a step, a window, a countertop and a piece of furniture.

17. A method of shielding a surface to be protected on a construction or remodeling job site, the method comprising:
providing a roll of elongate protective film material continuously wound upon itself for a plurality of turns, the surface shield material having an exposed tacky surface on an exterior of the roll and a non-tacky surface opposite the tacky surface;
providing a hand-held applicator tool having a handle portion and a film mounting portion;
mounting the roll to the film mounting portion;
directly engaging the tacky surface of the roll to the surface to be protected; and
guiding, using the handle portion, the tacky surface of the roll over the surface to be protected in a predetermined direction, thereby simultaneously rotating the roll and adhering the tacky surface to the surface to be protected, thereby providing an elongate shield over the surface to be protected.

18. The method of claim 17, wherein guiding the tacky surface of the roll comprises guiding the tacky surface of the roll along a substantially planar surface, the planar surface extending in one of a vertically oriented plane and a horizontally oriented plane.

19. The applicator tool of claim 1, wherein the handle portion is extendable and retractable to adjust an axial length of the handle.

20. A shield for protecting a surface comprising:
a carrier tube comprising a central aperture and an external surface; and
an elongate protective film material continuously wound upon itself in a roll for a plurality of turns, an inner surface of the roll coupled to the carrier tube external surface, the protective film material having an exposed tacky surface on an exterior of the roll and a non-tacky surface opposite the tacky surface, wherein the protective film material is configured to separate from the roll and adhere to a surface to be protected and wherein the roll is less than about 24 inches in width.
